(19) United States
(12) Patent Application Publication
(10) Pub. No.: US 2004/0229982 A1
(43) Pub. Date: Nov. 18, 2004

(54) Stabilized flame retardant additives and their use

(76) Inventors: Danielle F. Goossens, Nodebais (BE); Arthur G. Mack, Prairieville, LA (US)

Correspondence Address: EDGAR SPIELMAN, ALBEMARLE CORPORATION, 451 FLORIDA BLVD., BATON ROUGE, LA, 70801, US

(21) Appl. No.: 10/438,358

(22) Filed: May 14, 2003

(51) Int. Cl. C08K 5/15

(52) U.S. Cl. 524/114

(57) ABSTRACT

A flame retardant additive composition having enhanced thermal stability which comprises a blend formed from (A) tetrabromocyclooctane or dibromoethyl-dibromocyclohexane, or both and (B) halogenated aromatic epoxide and/or halogenated aromatic oligomer in which the halogen atoms are chlorine or bromine, or both, in an (A)/(B) weight ratio in the range of about 95/5 to about 60/40. Components (A) and (B) can be included to provide flame retardancy to various polymers especially styrenic polymers including foamed or foamable styrenic polymers, crystal styrenic polymers, impact-modified styrenic polymers, and blends of crystal styrenic polymers, impact-modified styrenic polymers. In all cases the thermal stability of component (A) is significantly increased by the copresence of component (B).

### BACKGROUND

1,2,5,6-Tetrabromocyclooctane (hereinafter often referred to more simply as tetrabromocyclooctane) and 1,2-dibromo-4-( 1,2-dibromoethyl)cyclohexane (hereinafter often referred to more simply as dibromoethyl-dibromocyclohexane) are useful flame retardants. Among potential uses for these compounds is as a flame retardant in injected molded styrenic polymers (e.g., crystal polystyrene and HIPS), and as a flame retardant for use in expanded or foamed styrenic polymer compositions, such as EPS and XPS. Unfortunately, the thermal stability characteristics of tetrabromocyclooctane and of dibromoethyl-dibromocyclohexane are not sufficient to avoid thermal degradation during some elevated temperature conditions encountered during the blending or molding of such polymeric products.

To provide tetrabromocyclooctane or dibromoethyl-dibromocyclohexane formulations that can be used as a flame retardant additive for both injection molded styrenic polymers and expanded or expandable styrenic polymers somewhat different properties are desired. In the former application prime requirements are the ability to achieve increased thermal stability, a UL94 V2 rating, and the ability to pass the IEC 695-2-1/2 Glow Wire test in HIPS compositions. For use in expanded or expandable styrenic polymer usage, adequate flame retardancy, increased thermal stability, and avoidance of surface roughness or surface defects are among prime requirements. In the case of extruded styrenic polymers such as XPS, other desirable properties are low corrosivity toward metals with which the hot blend comes into contact during processing, and the ability of the flame retardant to mix well with the other components in the extruder. In the case of expandable styrenic polymers such as EPS, a desirable property in addition to adequate flame retardancy, increased thermal stability, and avoidance of surface roughness or surface defects is for the flame retardant to have at least some solubility in the styrenic monomer(s), especially in styrene. Other properties desired in the case of flame retarded styrenic polymer compositions include lack of plasticizing effect on the substrate polymer, minimization of lump formation in the additive formulation during shipment and storage, and low cost.

It is to be noted that the target temperature of 200° C. for XPS and HIPS applications is much further away for tetrabromocyclooctane and dibromoethyl-dibromocyclohexane than the commonly-used flame retardant, hexabromocyclododecane. Accordingly, prior to this invention the possible use of either tetrabromocyclooctane or dibromoethyl-dibromocyclohexane as a flame retardant for these polymeric products was not considered feasible. Even in EPS applications where the maximum temperature encountered is typically about 130° C., tetrabromocyclooctane and dibromoethyl-dibromocyclohexane were deemed usable only in the second stage of a two-stage process because neither tetrabromocyclooctane nor dibromoethyl-dibromocyclohexane could survive the full polymerization process which usually lasts for several hours at about 130° C.

Thus a need thus exists for a way of increasing on a cost-effective basis the thermal stability of tetrabromocyclooctane and of dibromoethyl-dibromocyclohexane so that such compounds can be effectively used as a flame retardant for all such styrenic polymers at significantly higher temperatures than were possible heretofore. In addition, in fulfilling the above need it is desired to satisfy some, if not all, of the foregoing requirements or desired features in connection with usage of the flame retardant in injection molded styrenic polymers and in expanded or expandable styrenic polymers.

This invention has made it possible to fulfill the above need and to satisfy at least some if not all of these requirements or desired features. And the foregoing advantageous results can be achieved in a highly cost-effective manner.

### BRIEF SUMMARY OF THE INVENTION

Pursuant to this invention, a relatively small amount of a halogenated aromatic epoxide and/or halogenated aromatic epoxy oligomer when combined with tetrabromocyclooctane and/or dibromoethyl-dibromocyclohexane provides a composition having a substantially higher thermal stability as compared to tetrabromocyclooctane and/or dibromoethyl-dibromocyclohexane in the absence of the halogenated aromatic epoxide or halogenated aromatic epoxy oligomer. This is a surprising and unexpected discovery inasmuch as U.S. Pat. No. 5,281,639 points out that halogenated epoxy oligomer flame retardants, such as used as thermal stabilizers in the practice of the present invention, were themselves thermally stabilized in thermoplastic resins such as polystyrene and HIPS resins by the presence therein of an organic phosphite. In other words, the patent leads to the conclusion that the present thermal stabilizers themselves would need to be thermally stabilized in order to be used under elevated temperature conditions. Yet pursuant to this invention these same materials serve as thermal stabilizers for tetrabromocyclooctane and/or dibromoethyl-dibromocyclohexane under high temperature conditions in the absence of organic phosphite.

Thus pursuant to one of its embodiments, this invention provides a flame retardant additive composition having enhanced thermal stability which comprises a blend of (A) tetrabromocyclooctane and/or dibromoethyl-dibromocyclohexane and (B) halogenated aromatic epoxide and/or halogenated aromatic epoxy oligomer in an (A)/(B) weight ratio in the range of about 95/5 to about 60/40, and preferably in the range of about 90/10 to about 70/30.

It can be seen that in the present invention the halogenated aromatic epoxide or halogenated aromatic epoxy oligomer serves a dual function. First, it serves as a thermal stabilizer for the tetrabromocyclooctane or dibromoethyl-dibromocyclohexane, or for a mixture of both of them. Second, it also provides additional flame retardant effectiveness to the flame retardant additive composition.

In another embodiment of this invention the total of the amounts of (A) and (B) in the flame retardant additive composition is essentially 100 wt %, i.e., preferred flame retardant additive compositions contain no other deliberately added components. Only ordinary impurities such as manufacturing by-products or the like are present.

This invention further provides a flame retardant composition which comprises a thermoplastic polymer or blend of at least two thermoplastic polymers, with which has been blended a flame retardant quantity of (A) tetrabromocyclooctane or dibromoethyl-dibromocyclohexane, or both and (B) a halogenated aromatic epoxide and/or halogenated aromatic epoxy oligomer as described above. Components (A) and (B) should be blended in weight ratios (i.e., proportions) given above. Thus while components (A) and (B) and any other optional components can be blended with the thermoplastic polymer(s) separately, or singly and in a subcombination, it is preferred to blend at least components (A) and (B) as a preformed flame retardant additive composition of this invention. This will simplify the blending operation and minimize the likelihood of blending errors.

### FURTHER DETAILED DESCRIPTION OF THE INVENTION

### Halogenated Aromatic Epoxides

The halogenated aromatic epoxides used in the practice of this invention are preferably diglycidyl ethers of halogenated bisphenol-A, in which there are in the range of 2 to 4 halogen atom substituents on the bisphenol-A moiety, and in which the halogen atoms are chlorine and/or bromine, and preferably are all bromine atoms. The most preferred halogenated aromatic epoxide is the diglycidyl ether of tetrabromobisphenol-A. Methods for preparing such compounds are known and reported in the literature. See for example U.S. Pat. No. 4,873,309 to Corley, the full disclosure of which patent is incorporated herein by reference.

### Halogenated Aromatic Epoxy Oligomers

The halogenated aromatic epoxy oligomers which can be used in the practice of this invention are halogenated bisphenol-A type epoxy resins represented by formula (I):

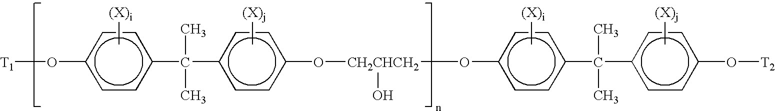

wherein X represents a halogen atom; i and j each represents an integer of from 1 to 4; n represents an average degree of polymerization in the range of 0.01 to 100, typically in the range of 0.5 to 100, preferably in the range of 0.5 to 50, and more preferably in the range of 0.5 to 1.5; and T₁ and T₂ are, independently and preferably:

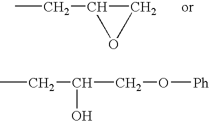

in which Ph represents a substituted or unsubstituted halogenated phenyl group, in which the ring is substituted by at least one chlorine or bromine atom. Non-limiting examples of Ph include a single or mixed isomer of bromophenyl, a single or mixed isomer of dibromophenyl, a single or mixed isomer of tribromophenyl, a single or mixed isomer of tetrabromophenyl, pentabromophenyl, a single or mixed isomer of chlorophenyl, a single or mixed isomer of dichlorophenyl, a single or mixed isomer of trichlorophenyl, a single or mixed isomer of tetrachlorophenyl, pentachlorophenyl, a single or mixed isomer of a tolyl group in which the ring is substituted by two bromine atoms, a single or mixed isomer of a tolyl group in which the ring is substituted by two chlorine atoms, and a single or mixed isomer of an ethylphenyl group in which the ring is substituted by two bromine atoms. Each halogen atom in a Ph group is preferably a bromine atom. As will be seen hereinafter, end blocking groups other than Ph can be used.

The halogenated aromatic epoxy oligomers used in the practice of this invention typically are amorphous oligomeric materials, with epoxy equivalent weights above 500 g/eq, and preferably above 800 g/eq. Thus unlike the crystalline diglycidyl ethers of tetrabromobisphenol-A with epoxy equivalent weights between 320 and 380 g/eq described in U.S. Pat. No. 6,127,558 for use in stabilizing hexabromocyclododecane, the halogenated aromatic epoxy oligomers used in the practice of this invention are highly effective even though they are not specially processed to achieve a crystalline structure, and are not characterized by such very low epoxy equivalent weights.

To prepare the halogenated aromatic epoxy oligomers used in the practice of this invention, various processes can be used. For example, these halogenated aromatic epoxy oligomers can be prepared by a process comprising condensation between a halogenated bisphenol A and epichlorohydrin, a process comprising reaction between a diglycidyl ether of a halogenated bisphenol A and a halogenated bisphenol A, and a process comprising heat reaction between a halogenated bisphenol-A type epoxy resin having an epoxy terminal group and a halogenated phenol, e.g., tribromophenol, pentabromophenol, trichlorophenol, dibromocresol, and dichlorocresol, in the presence of a basic catalyst.

In these processes, the reaction is preferably carried out at a temperature of from 100° C. to 230° C., and particularly from 140° C. to 200° C. Catalysts to be used in these processes include alkali metal hydroxides, e.g., sodium hydroxide; tertiary amines, e.g., dimethylbenzylamine; quaternary ammonium salts, e.g., tetramethylammonium chloride; phosphonium salts, e.g., ethyltriphenylphosphonium iodide; and phosphines, e.g., triphenylphosphine. Reaction solvents are not particularly needed and may or may not be used. For further details concerning synthesis of such halogenated aromatic epoxy oligomers, one may refer to Synthesis Examples 1-5 of U.S. Pat. No. 5,281,639.

Examples of one group of brominated bisphenol-A epoxy resins that can be used as component (B) are those compounds represented by the following formula (II):

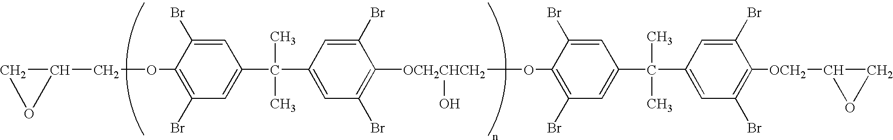

wherein n represents an average degree of polymerization in the range of 0.5 to 100, typically in the range of 0.5 to 50, and preferably in the range of 0.5 to 1.5.

Commercially-available flame retardants represented by formula (II) comprise various products depending on the polymerization degree (n). Such products include “F-2300”, “F-2300H”, “F-2400” and “F-2400H” from Bromokem (Far East) Ltd., “PRATHERM EP-16”, “PRATHERM EP-30”, “PRATHERM EP-100” and “PRATHERM EP-500” from Dainippon Ink & Chemicals, Incorporated, “SR-T1000”, “SR-T2000”, “SR-T5000” and “SR-T20000” from Sakamoto Yakuhin Kogyo Co., Ltd., and “EPIKOTE Resin-5112” from Resolution Performance Products.

Also suitable are brominated bisphenol-A epoxy resins wherein the epoxy group at each end of the resin has been blocked with a blocking agent, and resins wherein only the epoxy group at one end has been blocked with a blocking agent. Although no particular limitations are imposed on the blocking agent insofar as it is a compound permitting the ring-opening addition of the epoxy group, examples thereof can include phenols, alcohols, carboxylic acids, amines, isocyanates and the like, each containing a bromine atom. Among them, brominated phenols are preferred for improving flame retarding effects. Examples thereof can include dibromophenol, tribromophenol, pentabromophenol, dibromoethylphenol, dibromopropylphenol, dibromobutylphenol, dibromocresol and the like.

Examples of brominated bisphenol-A epoxy resins in which epoxy groups at both ends thereof are blocked with a blocking agent, can be represented by the following formulas (III) and (IV):

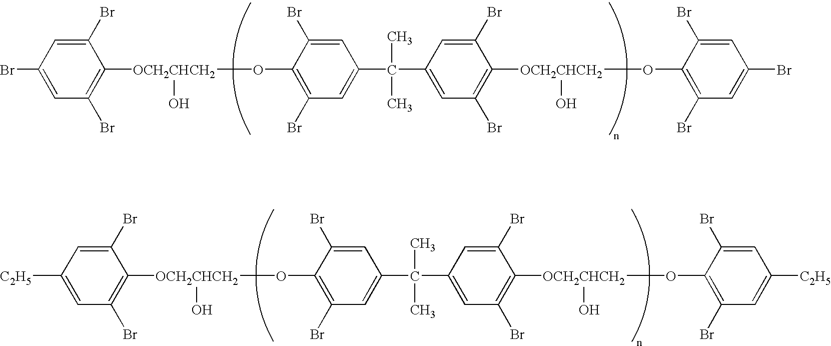

wherein n represents an average degree of polymerization in the range of 0.5 to 100, typically in the range of 0.5 to 50, and preferably in the range of 0.5 to 1.5.

Commercially-available products of formula (III) or (IV) include “PRATHERM EC-14”, “PRATHERM EC-20” and “PRATHERM EC-30” from Dainippon Ink & Chemicals, Incorporated, “TB-60” and “TB-62” from Tohto Chemical Co., Ltd., “SR-T3040” and “SR-T7040” from Sakamoto Yakuhin Kogyo Co., Ltd., and “EPIKOTE Resin-5203” from Resolution Performance Products.

Examples of brominated bisphenol-A epoxy resins in which the polymer having an epoxy group at only one end thereof blocked with a blocking agent can be represented by the formulas (V) and (VI):

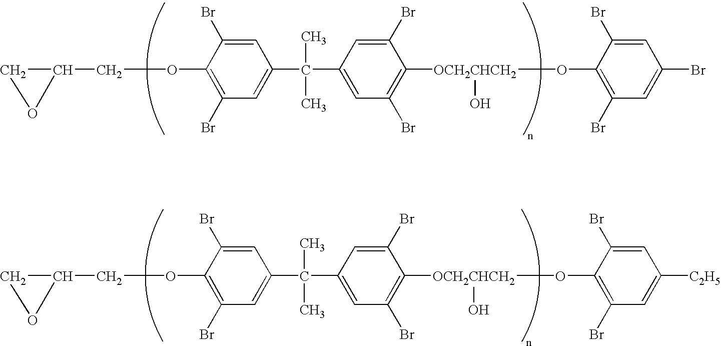

wherein n represents an average degree of polymerization in the range of 0.5 to 100, typically in the range of 0.5 to 50, and preferably in the range of 0.5 to 1.5.

Commercially-available products of formula (V) or (VI) include “PRATHERM EPC-15F” from Dainippon Ink & Chemicals, Incorporated, and “E5354” from Yuka Shell Epoxy Kabushiki Kaisha.

### Optional Components in the Additive Compositions

Other components can be included in the flame retardant additive compositions of this invention. Such optional components include assistants to further increase the flame-retardant effects. Examples of suitable flame-retardant assistants include antimony compounds, e.g., antimony trioxide, antimony tetroxide, antimony pentoxide, and sodium antimonate; tin compounds, e.g., tin oxide and tin hydroxide; molybdenum compounds, e.g., molybdenum oxide and ammonium molybdenum; zirconium compounds, e.g., zirconium oxide and zirconium hydroxide; boron compounds, e.g., zinc borate and barium metaborate; dicumylperoxide; and dicumyl. Other usefull components which may be included in the flame retardant additive composition include natural or synthetic zeolites, hydrotalcites, talc, hindered phenolic antioxidants, and light stabilizers. The proportions of these optional components relative to the tetrabromocyclooctane and/or dibromoethyl-dibromocyclohexane component are conventional and can be varied to suit the needs of any given situation.

### Flame-Retarded Polymer Compositions

Besides additive compositions, this invention also provides various flame-retarded compositions. One such composition comprises an injection moldable or extrudable thermoplastic polymer with which has been blended a flame retardant quantity of the above components (A) and (B) proportioned as described above.

This invention also provides a composition comprising a foamed or expanded styrenic polymer with which has been blended a flame retardant quantity of the above components (A) and (B) proportioned as described above.

Another polymer composition of this invention is a thermoplastic formulation suitable for use in producing expanded, i.e., foamed articles, from a styrenic polymer, which formulation comprises at least a styrenic polymer, a flame retardant quantity of the above components (A) and (B) proportioned as described above, and at least one blowing agent.

In formulating the above blends and formulations, components (A) and (B) can be blended the thermoplastic polymer or mixed with components of the foamable formulation individually and/or in any partial blend(s) of the components being used. However in order to minimize the possibility of blending errors or lack of substantial uniformity from formulation to formulation, and to facility the preparation of such formulations, it is preferable to employ a preformed blend of components (A) and (B) in which the components are already in the appropriate proportions.

The flame retardant quantity of components (A) and (B) proportioned as described above, can vary depending for example upon the particular thermoplastic polymer in which a combination of (A) and (B) is used, the service to which the ultimate molded or extruded or foamed article or shape is to be put, the thickness of the molded part, cost considerations, whether or not the thermoplastic formulation contains a flame retardant synergist, e.g. Sb₂O₃, or sodium antimonate (Na₂Sb₂O₆), whether or not the article formed from the thermoplastic formulation is being or to be expanded or not, and any adverse effect that the compound may have on the physical properties of the thermoplastic formulation. Generally, an empirical approach is relied upon in the art for determining the flame retardant quantity which best suits the particular needs for the intended usage of the end product.

Generally speaking, the quantity of components (A) and (B) should be sufficient to provide test specimens that can achieve a UL 94 test rating of at least V-2 with ⅛-inch thick specimens or a DIN 4102 test of at least B2 for a 10 mm thick specimen (for EPS and XPS). In most cases the flame retardant quantity will provide a total halogen content from (A) and (B) that falls in the range that of about 0.3 to about 10 wt %, and preferably in the range of about 0.5 to about 6 wt %, based on the weight of the thermoplastic polymer and components (A) and (B) blended therewith.

If the thermoplastic formulation is for use in forming a non-expanded article, typically a suitable flame retardant quantity is within the range of from about 2 to about 8 weight percent of a combination of (A) and (B) proportioned as described above, such as a flame retardant additive composition of this invention. If pursuant to embodiments of this invention where the polymer is a styrenic polymer such as crystal or rubber-modified polystyrene and no flame retardant synergist is used, a suitable flame retardant quantity of a combination of components (A) and (B) proportioned as described above is in the range of about 3 to about 6 weight percent.

When the thermoplastic formulation is suitable for and is used to produce expanded, i.e., foamed articles, from a styrenic polymer, the flame retardant quantity of a combination of components (A) and (B) proportioned as described above is typically in the range of about 0.5 to about 6 weight percent.

It will be appreciated that the proportions given herein for the specified components, although typical, are nonetheless approximate, as departures from one or more of the foregoing ranges are permissible whenever deemed necessary, appropriate or desirable in any given situation in order to achieve the desired flame retardancy (e.g., passing with at least a UL V-2 rating or passing the glow wire test) and thermal stability, while retaining the other physical properties required for the intended use of the finished composition. Thus to achieve the optimum combination of flame retardancy, thermal stability, and other properties, a few preliminary tests with the materials to be used is usually a desirable way to proceed in any given situation.

Thermoplastic polymers which can be flame retarded in accordance with this invention include styrenic polymers, e.g., polystyrene, rubber-modified polystyrene (HIPS resins), styrene-aciylonitrile copolymers (AS resins), aciylonitrile-butadiene-styrene copolymers (ABS resins), aciylonitrile-acrylic rubber-styrene copolymers (AAS resins), and acrylonitrile-ethylene/propylene rubber-styrene copolymers (AES resins); polyester resins, e.g., polybutylene terephthalate and polyethylene terephthalate; polycarbonate resins; polyphenylene oxide resins; and polymer alloys (polymer blends), e.g., an alloy of an ABS resin and polycarbonate, an alloy of an ABS resin and polybutylene terephthalate, and an alloy of polystyrene and polyphenylene oxide. Preferred thermoplastic polymers are styrenic resins (e.g., crystal (i.e., unreinforced) polystyrene, or a high-impact polystyrene), polyester resins, and polymer alloys containing a styrene resin.

Styrenic polymers used in the practice of this invention can be homopolymers, copolymers or block polymers and such polymers can be formed from such vinylaromatic monomers as styrene, ring-substituted styrenes in which the substituents are one or more C₁₋₆ alkyl groups and/or one or more halogen atoms, such as chlorine or bromine atoms, alpha-methylstyrene, ring-substituted alpha-methylstyrenes in which the substituents are one or more C₁₋₆ alkyl groups and/or one or more halogen atoms, such as chlorine or bromine atoms, vinylnaphthalene, and similar polymerizable styrenic monomers—i.e., styrenic compounds capable of being polymerized by means of peroxide or like catalysts into thermoplastic resins. Homopolymers and copolymers of simple styrenic monomers (e.g., styrene, p-methyl-styrene, 2,4-dimethylstyrene, alpha-methyl-styrene, p-chloro-styrene, etc.) are preferred from the standpoints of cost and availability.

Preferred high-impact polystyrene compositions of this invention have the capability of forming molded specimens of 1.6 and 3.2 millimeter thickness that pass the UL94 V2 test.

Impact-modified polystyrenes (IPS) that are preferably flame retaded pursuant to this invention may be medium-impact polystyrene (MIPS), high-impact polystyrene (HIPS), or blends of HIPS and GPPS (sometimes referred to as crystal polystyrene). These are all conventional materials. The rubber used in effecting impact modification is most often, but need not be, a butadiene rubber. High-impact polystyrene or blends containing a major amount (greater than 50 wt %) of high-impact polystyrene together with a minor amount (less than 50 wt %) of crystal polystyrene are particularly preferred as the substrate or host polymer.

The thermoplastic polymer compositions of this invention can be prepared by use of conventional blending equipment such as a twin-screw extruder, a Brabender mixer, or similar apparatus. As noted above, it is possible to separately add the individual components of the flame retardant additive compositions of this invention to the base polymer. Preferably, however, a preformed additive composition of this invention is blended with the base thermoplastic resin.

Conventional molding procedures, such as injection molding, extrusion, or like known procedures can be performed on the thermoplastic vinylaromatic formulations of this invention in producing finished articles therefrom. The articles so formed will not show significant color and viscosity degradation often experienced when using such techniques on GPPS or IPS which has been flame retarded with a brominated cycloaliphatic flame retardant.

Also provided by this invention are molded or extruded articles formed from any of the flame retardant moldable or extrudable thermoplastic polymer compositions of this invention. Yet another aspect of this invention is a method of producing a styrenic polymer article which comprises molding or extruding at a temperature of up to about 150° C., and preferably up to about 160° C., a melt blend of a moldable or extrudable styrenic polymer composition of this invention.

To form flame retardant extruded styrenic polymers such as XPS components a flame retardant quantity of (A) and (B) in proportions as described above is typically mixed with the styrenic polymer and a blowing agent in an extruder, and the resultant mixture is extruded through a die providing the desired dimensions of the product, such as boards of various thicknesses and one of several different widths. The combination of (A) and (B) proportioned as described above is highly advantageous for use in this process because such flame retardant combination has good thermal stability and exhibits low corrosivity toward metals with which the hot blend comes into contact in the process. Also the flame retardant combination mixes well with the other components in the extruder.

Flame retardant expandable styrenic polymers such as EPS are typically made pursuant to this invention by suspension polymerization of a mixture of styrene monomer(s) and a flame retadant quantity of a combination of (A) and (B) proportioned as described above in water to from beads of styrenic polymer. The small beads (e.g., averaging about 1 mm in diameter) so formed are then pre-expanded with steam and then molded again with steam to produce large blocks which can be of various large sizes, that will then be cut in the desired dimensions. For use in this process the combination of (A) and (B) proportioned as described above is desirable because it has sufficient solubility in the styrenic monomer(s), especially in styrene.

It will be understood that references above to a “combination of (A) and (B)”, is reference to (A) tetrabromocyclooctane and/or dibromoethyl-dibromocyclohexane and (B) a herein-described brominated epoxy oligomer.

Other Additive Components

The thermoplastic polymer compositions of this invention may contain other additives such as, for example, antioxidants, metal scavengers or deactivators, pigments, fillers, dyes, anti-static agents, processing aids, and other additional thermal stabilizers. Any additive which would materially detract from one or more of the advantageous performance properties of the composition of this invention when devoid of such additive, should not be included in the composition.

Various zeolites, such as zeolite-A, zeolite-X, zeolite-Y, zeolite-P, and zeolite ZSM-5, or mixtures of any two or more of them, are suitable for use in the practice of this invention. Also suitable is mordenite. In all cases, the zeolite should be used in the form of a fine dry powder, free of lumps or clumps. From the cost-effectiveness standpoint zeolite-A is a preferred material. In a preferred embodiment, the selected zeolite is calcined before use in order to reduce its water content without materially disrupting its physical structure or average pore size. For example, zeolite-A typically contains about 18.5% water, and calcining can prove useful in reducing this water content, thereby increasing its usefulness in the compositions of this invention. Other zeolites such as zeolite-X which typically contains about 24% water, and zeolite-Y which has a typical water content of about 25% may also be improved for use in this invention by calcining them prior to use to reduce their water contents but without destroying their structure. An advantage of zeolite ZSM-5 is its normal low content of water, about 5%.

Also useful in the EPS-type and XPS-type compositions of this invention are dicumylperoxide or dicumyl synergists. Such components are typically employed in the range of about 0.1 to about 0.4 wt %.

The following examples illustrate the practice and features of this invention. These examples are not intended to limit, and should not be construed as limiting, the scope of the invention.

### EXAMPLE 1

Dynamic TGA evaluations were performed on the compositions described in Table 1 wherein tetrabromocyclooctane (SAYTEX® BC-48, Albemarle Corporation) is signified by “BC-48” and PRATHERM EC-14 brominated epoxy oligomer (Dainippon Ink & Chemicals, Incorporated) is signified by “EC-14”. These TGA evaluations were performed over the range of 30 to 750° C. at a rate of temperature increase of 10° C. per minute. Table 1 wherein the percentages of the blends are by weight, summarizes the results obtained in these tests.

TABLE 1

| T ° C. | | BC-48 | | | |
|---|---|---|---|---|---|
| Weight | BC-48 | 95% | BC-48 90% | BC-48 85% | BC-48 80% |
| Loss % | 100% | EC-14 5% | EC-14 10% | EC-14 15% | EC-14 20% |
| 1% | 129.35 | 152.83 | 153.73 | 154.81 | 158.22 |
| 5% | 140.36 | 166.96 | 166.57 | 169.82 | 173.83 |
| 10% | 159.82 | 179.70 | 172.45 | 179.50 | 176.00 |
| 20% | 186.82 | 198.71 | 191.95 | 198.02 | 189.52 |

### EXAMPLE 2

Dynamic TGA evaluations were performed as in Example 1 on the compositions described in Table 2 wherein tetrabromocyclooctane (SAYTEX BC-48; Albemarle Corporation) is signified by “BC-48” and PRATHERM EP-16 brominated epoxy oligomer (Dainippon Ink & Chemicals, Incorporated) is signified by “EP-16”. The results are summarized in Table 2 in which the percentages of the blends are on a weight basis.

TABLE 2

| T ° C. Weight | BC-48 | BC-48 95% | BC-48 90% | BC-48 85% | BC-48 80% | BC-48 70% |
|---|---|---|---|---|---|---|
| Loss % | 100% | EP-16 5% | EP-16 10% | EP-16 15% | EP-16 20% | EP-16 30% |
| 1% | 128.55 | 154.12 | 157.52 | 157.06 | 164.58 | 167.49 |
| 5% | 139.74 | 186.28 | 194.02 | 191.90 | 201.69 | 204.68 |
| 10% | 157.98 | 188.24 | 195.52 | 210.88 | 220.21 | 222.05 |
| 20% | 185.97 | 200.04 | 199.95 | 227.52 | 222.76 | 231.05 |

### EXAMPLE 3

The procedure of Example 1 was repeated using blends of dibromoethyl-dibromocyclohexane (SAYTEX® BCL-462; Albemarle Corporation) signified by “BCL-462” with PRATHERM EP- 16 brorminated epoxy oligomer (signified by EP- 16). The results are summarized in Table 3 in which the percentages of the blends used are by weight.

TABLE 3

| T ° C. | | | | |
|---|---|---|---|---|
| Weight | BCL-462 | BCL-462 95% | BCL-462 90% | BCL-462 80% |
| Loss % | 100% | EP-16 5% | EP-16 10% | EP-16 20% |
| 1% | 131.66 | 135.17 | 137.55 | 139.24 |
| 5% | 153.01 | 173.02 | 175.12 | 176.08 |
| 10% | 169.34 | 193.89 | 196.29 | 198.46 |
| 20% | 195.02 | 201.29 | 216.97 | 220.46 |

### EXAMPLE 4

A group of tests were conducted to demonstrate some of the advantages in using the flame retardant blends of this invention in styrenic polymers. In this instance, the styrenic polymer used was Shell N-2000 MG polystyrene, and the flame retardant of this invention was a mixture of SAYTEX BC-48 flame retardant (tetrabromocyclooctane) or SAYTEX BCL-462 flame retardant (dibromoethyl-dibromocycloethane) stabilized with increasing of different stabilizers of this invention.

Preparation of Pellets Containing Brominated Epoxy Oligomer

The flame retardants identified in Table 4 below are converted into powder blends with a brominated epoxy oligomer identified in Table 4 below using a kitchen mixer/chopper. Into a bucket are placed 1300 g of the host polystyrene polymer (GPPS; Shell N 2000 MG), and a specified amount of the respective powder blends is mixed therewith. The resultant blend is introduced into a single screw extruder with a screw diameter of ¾ inch, and an L/D ratio of 25 for compounding. The extruder settings are set to give a temperature profile of 170-180-200-200° C. from hopper to the die and the screw speed is 100 rpm. This provides an average output of 4 kg/hr.

Compression Molding Procedure

The respective batches formed as above are first ground through a 4 mm sieve. Then 115 g of the ground material is poured into a 190×190 mm insert at room temperature. The insert containing the ground material is put between heated platens at 180° C. for 1 minute at about 20 kN. Then a pressure of 200 kN is applied for 7 more minutes. The insert is then cooled between 2 other platens at 20° C. for 8 minutes with a pressure of 200 kN. A plaque of 190×190×2.75(+/- 0.15) mm is then removed from the mould. Two plaques of 95×95 mm and 17 bars of 10×95 mm are cut out of the larger plaque. The bars were used for LOI evaluations. Table 4 summarizes results of evaluations of the test specimens.

TABLE 4

| | Loading | Br Content | Color of | MFI Results | |
|---|---|---|---|---|---|
| FR | (%) | (%) | Compound | (200°/2.16 kg) | LOI |
| Neat resin | | | Colorless | 7 g/10′ | 18.4 |
| BC-48 | 1 | 0.75 | | | 22 |
| | 3.01 | 2.25 | Discolored | degrades and | 25 |
| | | | (Brown) | X-links | |
| BC-48 + EC-14 (5%) | 1.01 | 0.75 | | | 21.9 |
| | 3.04 | 2.25 | Slightly | 43.8 g/10′ | 25.1 |
| | | | brown | | |
| BC-48 + EC-16 (5%) | 1.02 | 0.75 | | | 22.4 |
| | 3.06 | 2.25 | Colorless | 38.8 g/10′ | 25.4 |
| BC-48 + EC-14 (20%) | 1.05 | 0.75 | Discolored | | 21.7 |
| | | | (brown) | | |
| | 3.14 | 2.25 | | | 23.1 |
| BC-48 + EP-16 (20%) | 1.07 | 0.75 | Colorless | | 21.7 |
| | 3.21 | 2.25 | | | 24.3 |
| BC-48 + EP-16 (30%) | 3.32 | 2.25 | Colorless | | 23.5 |
| BCL-462 | 1.00 | 0.75 | Colorless | | 22.3 |
| | 3.01 | 2.25 | | | 24.1 |
| BCL-462 + EP-16 (10%) | 3.11 | 2.25 | Colorless | | 24.1 |

### EXAMPLE 5

Another group of tests were conducted to demonstrate some of the advantages in using the flame retardant blends of this invention in a HIPS type polymer. In this instance, the HIPS type polymer was formed by blending together 67.2 parts by weight of STYRON® 485-71 polymer and 28.8 parts by weight of STYRON® 678 E polymer, both from Dow Chemical Company. These two polymers were blended by grinding them through a 2 mm sieve. The blending procedure used for preparing the test specimens are as described in Example 4 except that the components used are those identified in Table 5 below. Injection molding was used for preparing the test specimens using a barrel temperature profile of 160-170-180-180° C. from hopper to nozzle and a mold temperature of40° C. For color evaluation, plaques of 60×60×2 mm were prepared. Also, UL bars of 3.2 and 1.6 mm thickness were prepared. Results of the evaluations on the test specimens are summarized in Table 5.

TABLE 5

| | | | | | | | | | | | | |
|---|---|---|---|---|---|---|---|---|---|---|---|---|
| Styron 485-71 | 67.2 | 67.2 | 67.2 | 67.2 | 67.2 | 67.2 | 67.2 | 67.2 | 67.2 | 67.2 | 67.2 | 70 |
| Styron 678 E | 28.8 | 28.8 | 28.8 | 28.8 | 28.8 | 28.8 | 28.8 | 28.8 | 28.8 | 28.8 | 28.8 | 30 |
| BC-48 | 4 | | | | | | | | | | | |
| BC-48 (95%) + EC-14 (5%) | | 4 | | | | | | | | | | |
| BC-48 (80%) + EC-14 (20%) | | | 4 | | | | | | | | | |
| BC-48 (95%) + EP-16 (5%) | | | | 4 | | | | | | | | |
| BC-48 (80%) + EP-16 (20%) | | | | | 4 | | | | | | | |
| BC-48 (70%) + EP-16 (30%) | | | | | | 4 | | | | | | |
| BCL-462 | | | | | | | 4 | | | | | |
| BCL-462 (95%) + EP-16 (5%) | | | | | | | | 4 | | | | |
| BCL-462 (90%) + EP-16 (10%) | | | | | | | | | 4 | | | |
| BCL-462 (80%) + EP-16 (20%) | | | | | | | | | | 4 | | |
| BCL-462 (70%) + EP-16 (30%) | | | | | | | | | | | 4 | |
| Color | | | | | | | | | | | | |
| L* | 53.31 | 55.31 | 56.45 | 62.92 | 86.21 | 88.13 | 81.52 | 88.97 | 89.05 | 89.23 | 89.31 | 87.07 |
| a* | 2.57 | 2.32 | 2.18 | 3 | −1.97 | −2.09 | 0.67 | −2.28 | −2.16 | −2.07 | −2.06 | −1.35 |
| b* | −3.09 | −1.79 | −2.2 | 2.17 | 2.7 | −0.1 | 5.7 | −0.68 | −1.55 | −1.95 | −2.16 | 0.53 |
| YI D1925 | −5.79 | −1.98 | −3.39 | 9.65 | 3.5 | −2.3 | 12.55 | −3.66 | −5.33 | −6.04 | −6.46 | −0.27 |
| DE* | 34.18 | 32.06 | 30.94 | 24.59 | 2.42 | 1.44 | 7.85 | 2.44 | 2.98 | 3.37 | 3.57 | 0.00 |
| MFI (200° C./5 kg | 16.64 | | | 17.95 | | 17.24 | 18.17 | | | | 16.97 | 12.17 |
| UL-VB @ 1.6 mm | V-2 | | | | | V-2 | V-2 | | | | V-2 | |
| UL-VB @ 3.2 mm | V-2 | | | | | V-2 | V-2 | | | | V-2 | |

### EXAMPLE 6

Dynamic TGA determinations were conducted on combinations of BC-48 and diglycidyl ether of tetrabromobisphenol-A signified by DGE over the range of 30 to 750° C. at the rate of temperature increase of 10° C. per minute. The compositions tested and the results thereon are summarized in Table 6 wherein the values given are in degrees C.

TABLE 6

| Temp. | | | | | |
|---|---|---|---|---|---|
| for a | | BC-48 | BC-48 | | |
| specified | BC-48 | 95% | 90% | BC-48 85% | BC-48 80% |
| wt % loss | 100% | DGE 5% | DGE 10% | DGE 15% | DGE 20% |
| 1% | 134.90 | 151.72 | 148.16 | 153.79 | 160.91 |
| 5% | 150.06 | 185.31 | 181.74 | 189.45 | 198.48 |
| 10% | 169.74 | 201.04 | 200.82 | 206.14 | 217.91 |
| 20% | 191.81 | 208.75 | 204.66 | 210.17 | 226.87 |

### EXAMPLE 7

The procedure of Example 6 was repeated using combinations of BCL-462 and diglycidyl ether of tetrabromobisphenol-A signified by DGE. The results are summarized in Table 7.

TABLE 7

| Temp. | | | | | |
|---|---|---|---|---|---|
| for a | | BCL-462 | BCL-462 | BCL-462 | BCL-462 |
| specified | BCL-462 | 95% | 90% | 85% | 80% |
| wt % loss | 100% | DGE 5% | DGE 10% | DGE 15% | DGE 20% |
| 1% | 149.09 | 152.54 | 137.08 | 161.04 | 159.90 |
| 5% | 158.09 | 190.98 | 176.31 | 197.99 | 196.53 |
| 10% | 176.41 | 205.50 | 197.25 | 215.08 | 213.78 |
| 20% | 201.53 | 209.37 | 215.90 | 230.44 | 225.36 |

Components referred to herein by chemical name or formula, whether referred to in the singular or plural, are identified as they exist prior to coming into contact with another substance referred to by chemical name or chemical type (e.g., another component, a solvent, or a polymer). Also, even though the claims hereinafter may refer to substances, components and/or ingredients in the present tense (e.g., “comprises” or “is”), the reference is to the substance, component or ingredient as it existed at the time just before it was first contacted, blended or mixed with one or more other substances, components and/or ingredients in accordance with the present disclosure.

That which is claimed is:

1. A flame retardant additive composition having enhanced thermal stability which comprises a blend formed from (A) 1,2,5,6-tetrabromocyclooctane or 1,2-dibromo-4-(1,2-dibromoethyl)cyclohexane, or both and (B) halogenated aromatic epoxide and/or halogenated aromatic epoxy oligomer in which the halogen atoms are chlorine or bromine, or both, in an (A)/(B) weight ratio in the range of about 95/5 to about 60/40.

2. An additive composition of claim 1 wherein (B) is a halogenated aromatic epoxy oligomer represented by the formula: 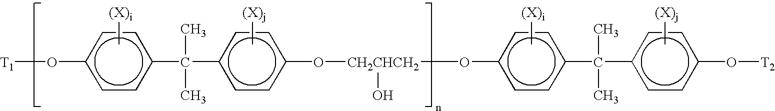
wherein X represents, independently, a chlorine or bromine atom; i and j each represents an integer of from 1 to 4; n represents an average degree of polymerization in the range of 0.01 to 100; and T₁ and T₂ are, independently: 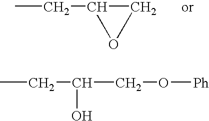
in which Ph represents a substituted or unsubstituted halogenated phenyl group, and in which the ring is substituted by at least one chlorine or bromine atom.

3. An additive composition of claim 2 wherein said average degree of polymerization is in the range of 0.5 to 50.

4. An additive composition of claim 2 wherein said average degree of polymerization is in the range of 0.5 to 1.5.

5. An additive composition of any of claims 1-4 wherein said weight ratio is in the range of about 90/10 to about 70/30.

6. An additive composition of claim 1 wherein (B) is a halogenated aromatic epoxy oligomer represented by the formula: 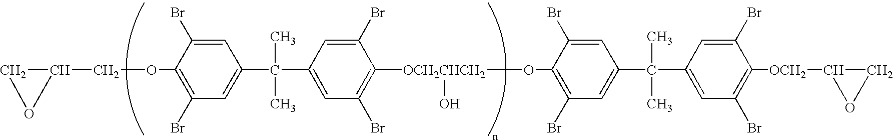
wherein n represents an average degree of polymerization in the range of 0.5 to 100.

7. An additive composition of claim 6 wherein said average degree of polymerization is in the range of 0.5 to 50.

8. An additive composition of claim 6 wherein said average degree of polymerization is in the range of 0.5 to 1.5.

9. An additive composition of any of claims 6-8 wherein said weight ratio is in the range of about 90/10 to about 70/30.

10. An additive composition of claim 1 wherein (B) is a halogenated aromatic epoxy oligomer represented by the formula: 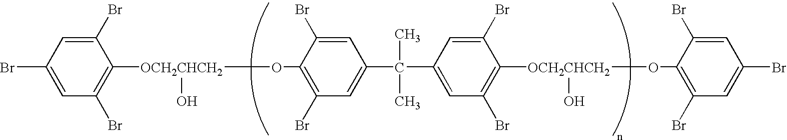
wherein n represents an average degree of polymerization in the range of 0.5 to 100.

11. An additive composition of claim 10 wherein said average degree of polymerization is in the range of 0.5 to 50.

12. An additive composition of claim 10 wherein said average degree of polymerization is in the range of 0.5 to 1.5.

13. An additive composition of any of claims 10-12 wherein said weight ratio is in the range of about 90/10 to about 70/30.

14. An additive composition of claim 1 wherein (B) is a halogenated aromatic epoxy oligomer represented by the formula: 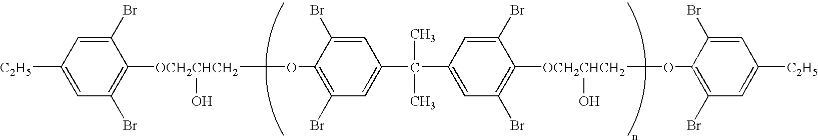
wherein n represents an average degree of polymerization in the range of 0.5 to 100.

15. An additive composition of claim 14 wherein said average degree of polymerization is in the range of 0.5 to 50.

16. An additive composition of claim 14 wherein said average degree of polymerization is in the range of 0.5 to 1.5.

17. An additive composition of any of claims 14-16 wherein said weight ratio is in the range of about 90/10 to about 70/30.

18. An additive composition of claim 1 wherein (B) is a halogenated aromatic epoxy oligomer represented by the formula: 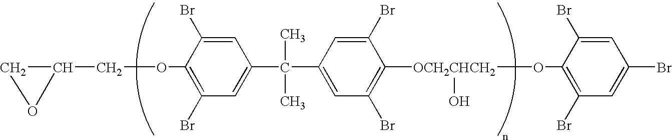
wherein n represents an average degree of polymerization in the range of 0.5 to 100.

19. An additive composition of claim 18 wherein said average degree of polymerization is in the range of 0.5 to 50.

20. An additive composition of claim 18 wherein said average degree of polymerization is in the range of 0.5 to 1.5.

21. An additive composition of any of claims 18-20 wherein said weight ratio is in the range of about 90/10 to about 70/30.

22. An additive composition of claim 1 wherein (B) is a halogenated aromatic epoxy oligomer represented by the formula: 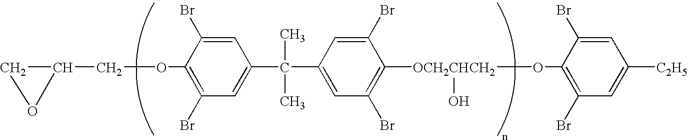
wherein n represents an average degree of polymerization in the range of 0.5 to 100.

23. An additive composition of claim 22 wherein said average degree of polymerization is in the range of 0.5 to 50.

24. An additive composition of claim 22 wherein said average degree of polymerization is in the range of 0.5 to 1.5.

25. An additive composition of any of claims 22-24 wherein said weight ratio is in the range of about 90/10 to about 70/30.

26. An additive composition of claim 1 wherein (B) is a halogenated aromatic epoxide in which the halogen atoms are chlorine or bromine, or both.

27. An additive composition of claim 26 wherein said epoxide is the diglycidyl ether of tetrabromobisphenot-A.

28. A flame retardant styrenic polymer composition which comprises a styrenic polymer and flame retardant amount of a flame retardant resulting from inclusion in the styrenic polymer of (A) 1,2,5,6-tetrabromocyclooctane or 1,2-dibromo-4-(1,2-dibromoethyl)cyclohexane, or both and (B) halogenated aromatic epoxide and/or halogenated aromatic oligomer in which the halogen atoms are chlorine or bromine, or both, in an (A)/(B) weight ratio in the range of about 95/5 to about 60/40.

29. A flame retardant composition of claim 28 wherein said composition is a styrenic polymer foam composition resulting from inclusion in the foam recipe before or during formation of the foam of a flame retardant amount of (A) 1,2,5,6-tetrabromocyclooctane or 1,2-dibromo-4-(1,2-dibromoethyl)cyclohexane, or both and (B) halogenated aromatic epoxy oligomer in which the halogen atoms are chlorine or bromine, or both, in an (A)/(B) weight ratio in the range of about 95/5 to about 60/40.

30. A composition of claim 29 wherein (B) is a halogenated aromatic epoxy oligomer as defined in any of claims 2, 6, 10, 14, 18, or 22.

31. A composition of claim 29 wherein (B) is a halogenated aromatic epoxy oligomer as defined in any of claims 2, 6, 10, 14, 18, or 22, and wherein the average degree of polymerization of the halogenated aromatic epoxy oligomer is in the range of 0.5 to 1.5.

32. A composition of any of claims 29-31 wherein said styrenic polymer foam composition is in the form of an extruded styrenic polymer foam.

33. A composition as in claim 32 wherein said extruded styrenic polymer foam is composed of at least 80 wt % of polymerized styrene.

34. A composition as in any of claims 29-31 wherein said styrenic polymer foam composition is in the form of expandable styrenic polymer beads or granules.

35. A composition as in claim 34 wherein the styrenic polymer of said expandable styrenic beads or granules is composed of an average of at least 80 wt % of polymerized styrene.

36. A flame retardant composition of claim 28 wherein said composition is a high-impact polystyrene polymer or a crystal polystyrene polymer, or a blend thereof.

37. A flame retardant composition of claim 28 wherein (B) is halogenated aromatic epoxide in which the halogen atoms are chlorine or bromine, or both.

38. An additive composition of claim 37 wherein said epoxide is the diglycidyl ether of tetrabromobisphenol-A.

39. In a method of preparing an extruded styrenic foam from a foamable molten styrenic polymer mixture, the improvement which comprises including in said mixture a flame retardant amount of (A) 1,2,5,6-tetrabromocyclooctane or 1,2-dibromo-4-(1,2-dibromoethyl)cyclohexane, or both and (B) halogenated aromatic epoxide and/or halogenated aromatic oligomer in which the halogen atoms are chlorine or bromine, or both, in an (A)/(B) weight ratio in the range of about 95/5 to about 60/40.

40. In a method of preparing expandable styrenic beads or granules from an expandable styrenic polymer mixture, the improvement which comprises including in said mixture a flame retardant amount of (A) 1,2,5,6-tetrabromocyclooctane or 1,2-dibromo-4-(1,2-dibromoethyl)cyclohexane, or both and (B) halogenated aromatic epoxide and/or halogenated aromatic oligomer in which the halogen atoms are chlorine or bromine, or both, in an (A)/(B) weight ratio in the range of about 95/5 to about 60/40.

41. The improvement of either of claims 39 or 40 wherein (B) is a halogenated aromatic epoxy oligomer as defined in any of claims 2, 6, 10, 14, 18, or 22.

42. The improvement of either of claims 39 or 40 wherein (B) is a halogenated aromatic epoxy oligomer as defined in any of claims 2, 6, 10, 14, 18, or 22, and wherein the average degree of polymerization of the halogenated aromatic epoxy oligomer is in the range of 0.5 to 1.5.

43. The improvement of either of claims 39 or 40 wherein (B) is a halogenated aromatic epoxide in which the halogen atoms are chlorine or bromine, or both.

44. The improvement of claim 43 wherein said epoxide is the diglycidyl ether of tetrabromobisphenol-A.

45. A molded or extruded article formed from a composition of claim 36.

46. A method of producing a flame-retarded article which comprises molding or extruding at a temperature of up to 250° C. a melt blend of a composition of claim 36.
